(19) United States
(12) Patent Application Publication
(10) Pub. No.: US 2005/0175726 A1
(43) Pub. Date: Aug. 11, 2005

(54) Forming apparatus for forming a foamed body from a foamable plastic material under pressure control

(76) Inventor: Deng-Min Yang, Taichung Hsien (TW)

Correspondence Address: CHRISTIE, PARKER & HALE, LLP, PO BOX 7068, PASADENA, CA, 91109-7068, US

(21) Appl. No.: 10/773,996

(22) Filed: Feb. 6, 2004

(51) Int. Cl. B29C 44/08

(52) U.S. Cl. 425/170; 425/233; 425/817 R

(57) ABSTRACT

A forming apparatus for forming a foamed body from a foamable plastic material under pressure control includes a pressure chamber, a mold unit, and a pressure-adjusting device. The mold unit is mounted in the pressure chamber, and includes an upper mold and a lower mold. When the upper and lower molds are interconnected, a mold cavity is defined therebetween. The plastic material is placed into the mold cavity so as to undergo cross-linking and foaming, thereby forming a blank. The blank generates a foaming pressure within the mold cavity. Subsequently, the pressure in the pressure chamber is adjusted to a forming pressure by the operation of the pressure-adjusting device so that the forming pressure is applied to the foamed blank so as to permit the foamed blank to expand, thereby forming the foamed body under the forming pressure.

### BACKGROUND OF THE INVENTION

1. Field of the Invention

This invention relates to a forming apparatus for forming a foamed body from a foamable plastic material, and more particularly to a forming apparatus for forming a foamed body from a foamable plastic material under pressure control, which enables a foamed blank to expand so as to form the foamed body under a forming pressure.

2. Description of the Related Art

In a conventional process for making an ethylene vinyl acetate (EVA) foamed sole, an EVA plastic material is injected into a mold cavity in a primary mold. In a first molding process, the primary mold is heated to a temperature, at which the EVA plastic material undergoes cross-linking and foaming. Thereafter, the primary mold is opened so that the material expands instantly to form a foamed blank. To cool the foamed blank and fix its shape for subsequent treatment in a second molding process, typically, the foamed blank is placed in a room for a period of about two days. However, because the air pressure within the room will change during the two-day period of cooling the foamed blank, the qualification rate of the cooled blanks is reduced to about 70%. As a result, when the size of the cooled blank is too large, it is necessary to trim the same. In addition, when the size of the cooled blank is too small, it is downsized, i.e. moved to another production line for making a smaller-size product. When the cooled blank has a standard size, it is placed into a secondary mold so as to undergo heating, compressing, and cooling, thereby forming a product that has appropriate patterns. The second molding process and the operations of trimming and downsizing take about three days.

To increase the qualification rate of cooled blanks, in an improved forming apparatus, a foamed blank removed from a primary mold is directly placed into and cooled within a temperature controllable tunnel type oven for a period of about 8 hours to fix its shape. However, upon opening of the primary mold, as the air pressure acting on the foamed blank may still change with ambient conditions, the use of the improved forming apparatus can only increase the qualification rate to about 85%. Moreover, it is still necessary to perform trimming and downsizing operations, thereby resulting in an inefficient forming process.

### SUMMARY OF THE INVENTION

The object of this invention is to provide a forming apparatus for forming a foamed body from a foamable plastic material under pressure control, which enables a blank to expand so as to form the foamed body under a forming pressure, thereby resulting in an efficient forming process.

According to this invention, a forming apparatus for forming a foamed body from a foamable plastic material under pressure control includes a pressure chamber, a mold unit, and a pressure-adjusting device. The mold unit is mounted in the pressure chamber, and includes an upper mold and a lower mold. When the upper and lower molds are interconnected, a mold cavity is defined therebetween. The plastic material is placed into the mold cavity so as to undergo cross-linking and foaming, thereby forming a blank. The blank generates a foaming pressure within the mold cavity. Subsequently, the pressure in the pressure chamber is adjusted to a forming pressure by the operation of the pressure-adjusting device so that the forming pressure is applied to the foamed blank so as to permit the foamed blank to expand, thereby forming the foamed body under the forming pressure.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a schematic view of the first preferred embodiment of a forming apparatus for forming a foamed body from a foamable plastic material under pressure control according to this invention, illustrating how the plastic material is placed into a first mold cavity in a first mold unit;

FIG. 2 is a schematic view of the first preferred embodiment, illustrating how a foamed blank is formed from the plastic material within the first mold cavity in the first mold unit;

FIGS. 3 and 4 are schematic views of the first preferred embodiment, illustrating how the foamed blank is moved from the first mold unit into a second lower mold;

FIG. 5 is a schematic view of the first preferred embodiment, illustrating how a second upper mold is moved to engage the second lower mold so that a second mold cavity is defined therebetween;

FIG. 6 is a schematic view of the first preferred embodiment, illustrating how the foamed body is formed from the foamed blank within the second mold cavity between the second upper and lower molds;

FIG. 7 is a schematic view of the first preferred embodiment, illustrating how the foamed body is cooled within the second mold cavity between the second upper and lower molds;

FIG. 8 is a schematic view of the first preferred embodiment, illustrating how the second upper mold is removed from the second lower mold;

FIG. 9 is a perspective view of the foamed blank formed within the first mold unit of the first preferred embodiment;

FIG. 10 is a perspective view of the foamed body formed within the second mold cavity between the second upper and lower molds of the first preferred embodiment;

FIG. 11 is a schematic view of the second preferred embodiment of a forming apparatus for forming a foamed body from a foamable plastic material under pressure control according to this invention, illustrating how the plastic material is placed into a mold cavity in a mold unit;

FIG. 12 is a schematic view of the second preferred embodiment, illustrating how a foamed blank is formed within the mold cavity in the mold unit; and

FIG. 13 is a schematic view of the second preferred embodiment, illustrating how the mold unit is opened within a pressure chamber so that the foamed body is formed from the foamed blank.

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

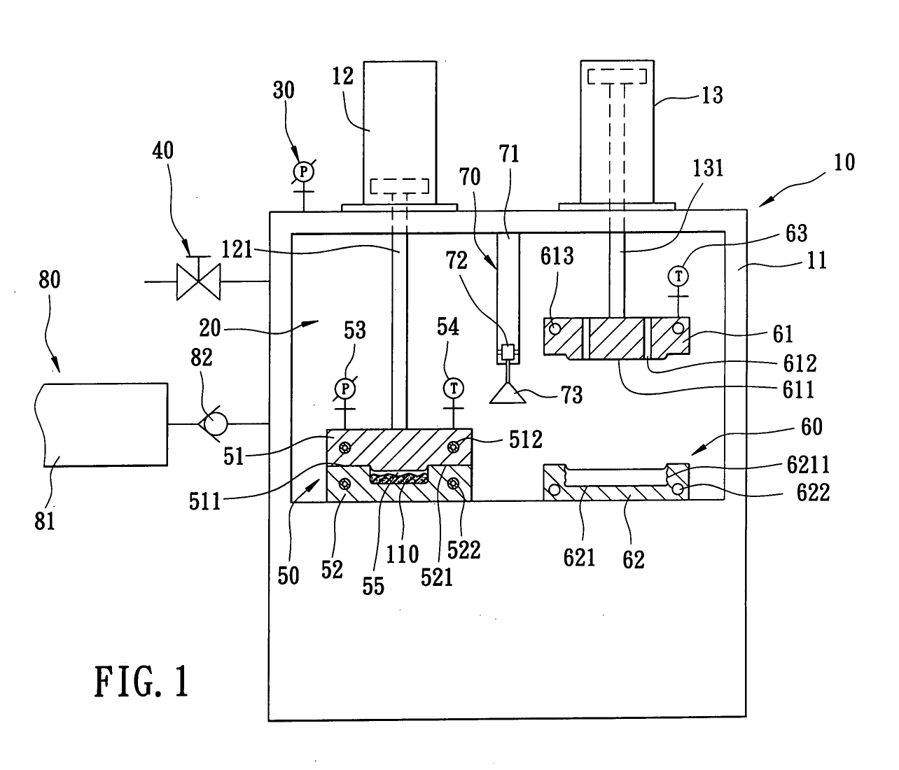

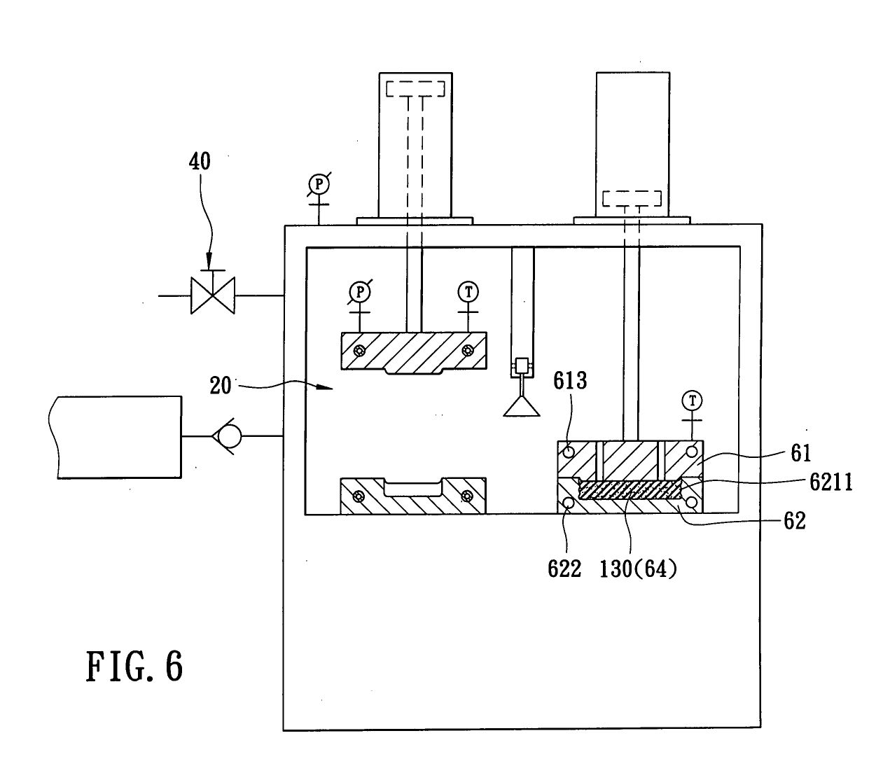

Referring to FIGS. 1, 2, and 3, the first preferred embodiment of a forming apparatus for forming a foamed body 130 (see FIGS. 6, 7, 8, 10) from a foamable plastic material 110 under pressure control according to this invention is shown to include a machine bed unit 10, a pressure chamber 20, a pressure-sensing element 30, a pressure-adjusting valve 40, a first mold unit 50, a second mold unit 60, a conveying unit 70, and a pressure-supplying unit 80. The pressure-adjusting valve 40 and the pressure-supplying unit 80 constitute cooperatively a pressure-adjusting device.

The machine bed unit 10 includes a machine bed 11, and first and second hydraulic cylinders 12, 13 mounted on the machine bed 11. Each of the first and second hydraulic cylinders 12, 13 has an extendible and retractable piston rod 121, 131 that extends into the pressure chamber 20 and that is connected to a respective one of the first and second mold units 50, 60 so as to open and close the first and second mold units 50, 60.

The pressure chamber 20 is formed within the machine bed 11.

The pressure-sensing element 30 is mounted on the machine bed 11, and is configured as a pressure gauge for sensing the pressure in the pressure chamber 20.

The pressure-adjusting valve 40 is mounted on the machine bed 11, and is operable to reduce the pressure in the pressure chamber 20. As such, the pressure-adjusting valve 40 can be adjusted and set for pressure relief so as to maintain the pressure in the pressure chamber 20 at a predetermined pressure.

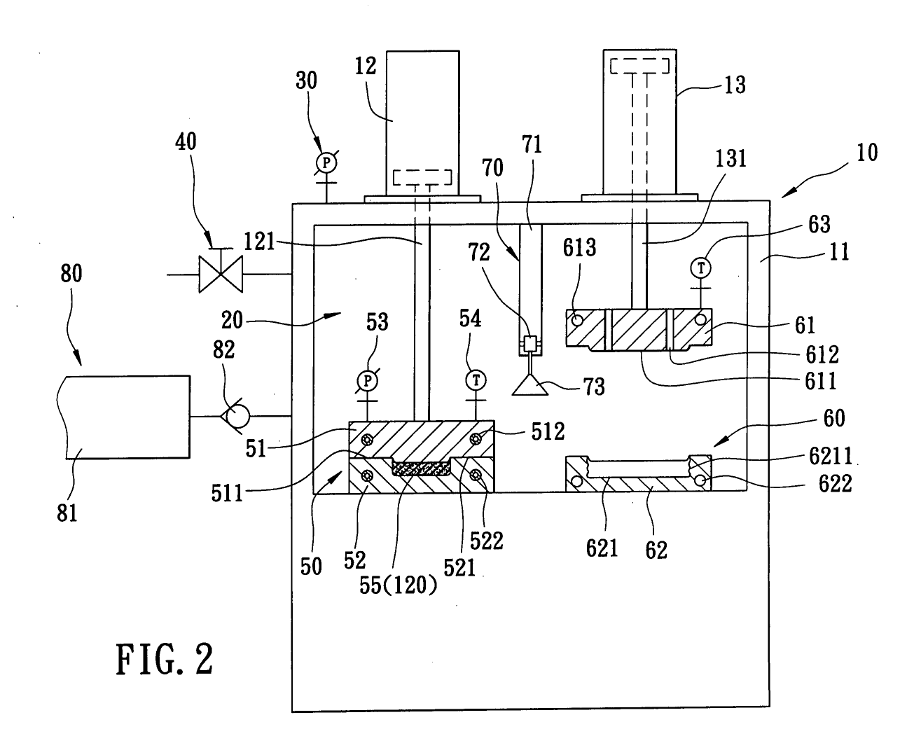

The first mold unit 50 is mounted in the pressure chamber 20, and includes a first upper mold 51 disposed movably in the pressure chamber 20 and connected fixedly to the piston rod 121 of the first hydraulic cylinder 12, a first lower mold 52 fixed in the pressure chamber 20, a pressure-sensing element 53 mounted on the first upper mold 51, and a first temperature-sensing element 54 mounted on the first upper mold 51. Several heating elements 512, 522 are provided within the first upper and lower molds 51, 52 for heating the same. When the first upper mold 51 is moved to engage the first lower mold 52, inner side surfaces 511, 521 of the first upper and lower molds 51, 52 define a first mold cavity 55 therebetween. The pressure-sensing element 53 is configured as a pressure gauge for sensing the pressure in the first mold cavity 55 in the first mold unit 50. The first temperature-sensing element 54 is configured as a thermometer for sensing the temperature of the first upper and lower molds 51, 52. The foamable plastic material 110 is injected into the first mold cavity 55 in the first mold unit 50, as shown in FIG. 1, so as to undergo cross-linking and foaming, thereby forming a foamed blank 120, as shown in FIG. 2.

The second mold unit 60 is mounted in the pressure chamber 20, and includes a second upper mold 61 disposed movably in the pressure chamber 20 and connected fixedly to the piston rod 131 of the second hydraulic cylinder 13, a second lower mold 62 fixed in the pressure chamber 20, and a second temperature-sensing element 63. The second upper mold 61 has an inner side surface 611, several air passages 612, and several cooling-water passages 613. The second lower mold 62 has an inner side surface 621 and several cooling-water passages 622. The inner side surface 621 is formed with patterns 6211. The second temperature-sensing element 63 is configured as a thermometer for sensing the temperatures of the second upper and lower molds 61, 62. When the second mold unit 60 is closed, the inner side surfaces 611, 621 of the second upper and lower molds 611, 621 define a second mold cavity 64 (see FIG. 6) therebetween, which is communicated with the pressure chamber 20 via the air passages 612 and which has a volume larger than that of the first mold cavity 55.

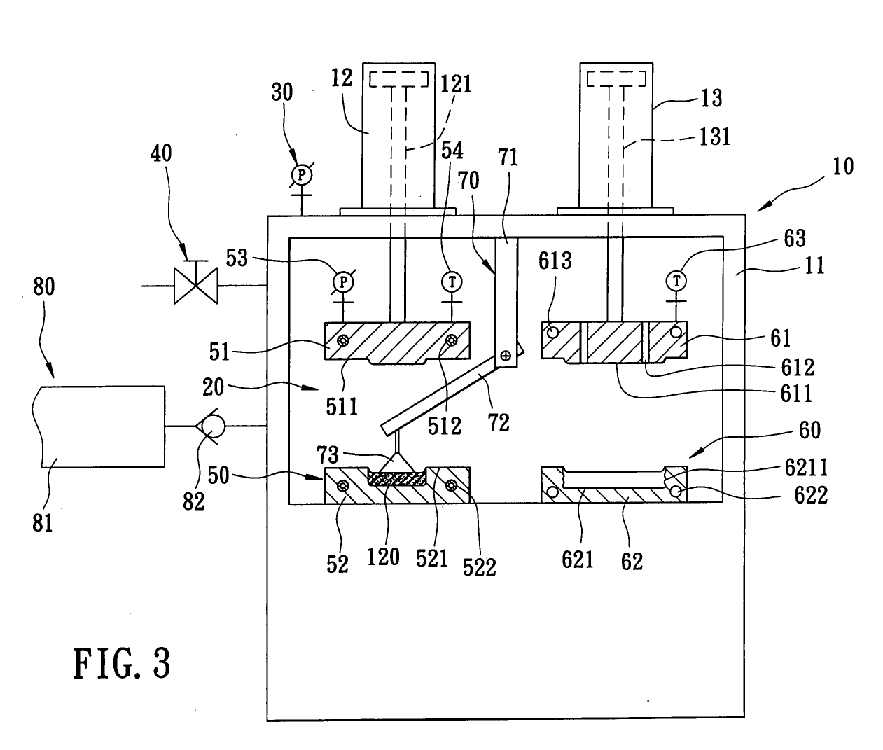

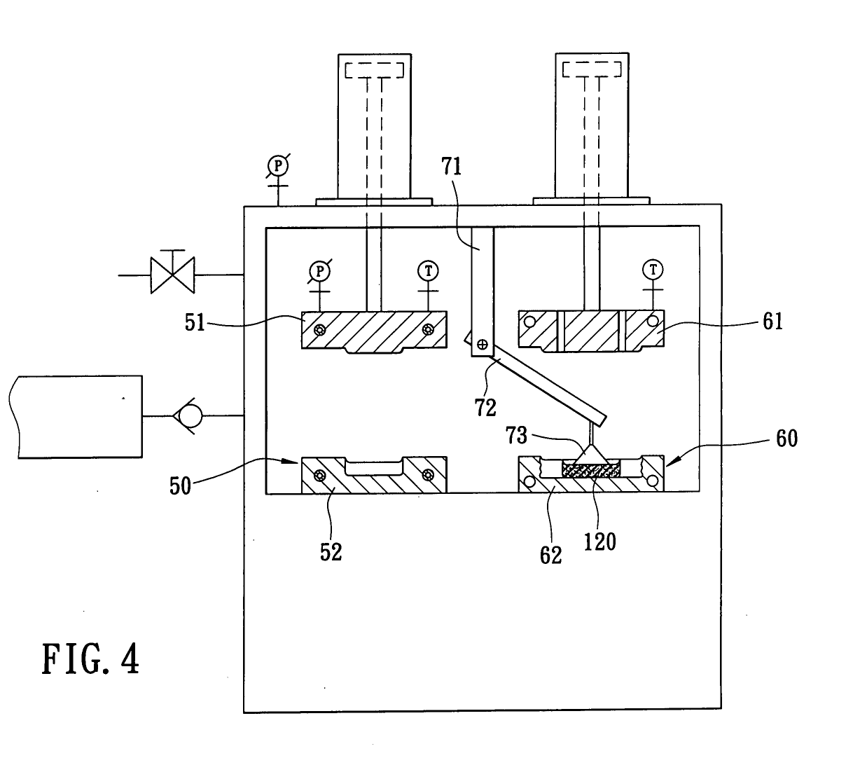

The conveying unit 70 is mounted in the pressure chamber 20, is located between the first and second mold units 50, 60, and includes a rotating shaft 71 journalled in the machine bed 11, a connecting rod 72 connected pivotally to a lower end of the rotating shaft 71 and swingable relative to the rotating shaft 71, and a suction cup 73 mounted fixedly on a free end of the connecting rod 72. The rotating shaft 71 and the connecting rod 72 can cooperate with each other to move the suction cup 73 between the first and second mold units 50, 60 under automatic control. As such, when the first upper mold 51 is removed from the first lower mold 52, the foamed blank 120 can be sucked by the suction cup 73 to move from the first lower mold 52 into the second lower mold 62, as shown in FIGS. 3 and 4.

The pressure-supplying unit 80 is connected to the machine bed unit 10, and includes a pressure source 81 configured as an air compressor and in fluid communication with the pressure chamber 20, and a control valve 82 disposed between the pressure source 81 and the pressure chamber 20 and operable to permit an increase in the pressure in the pressure chamber 20.

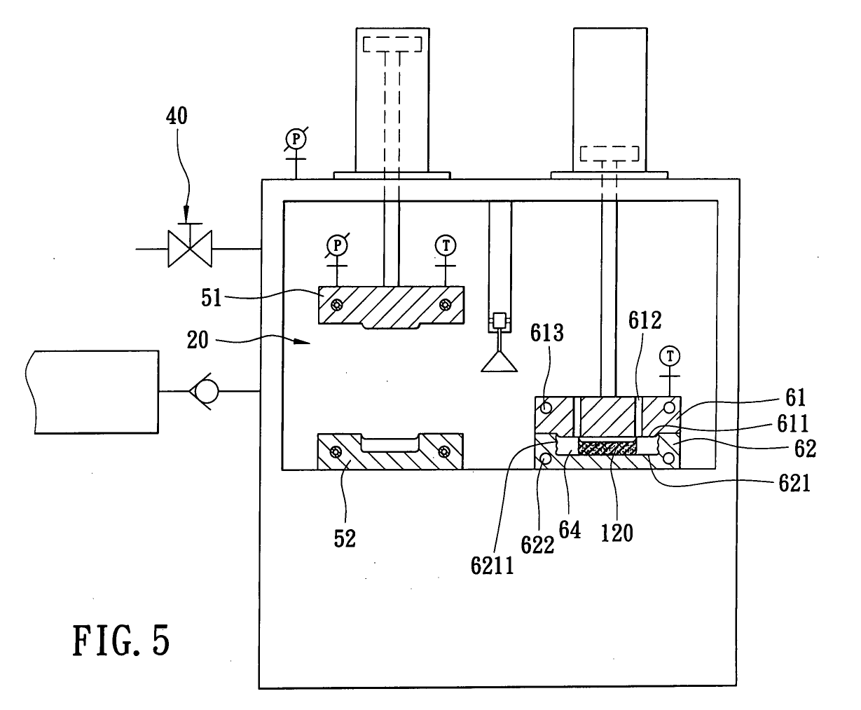

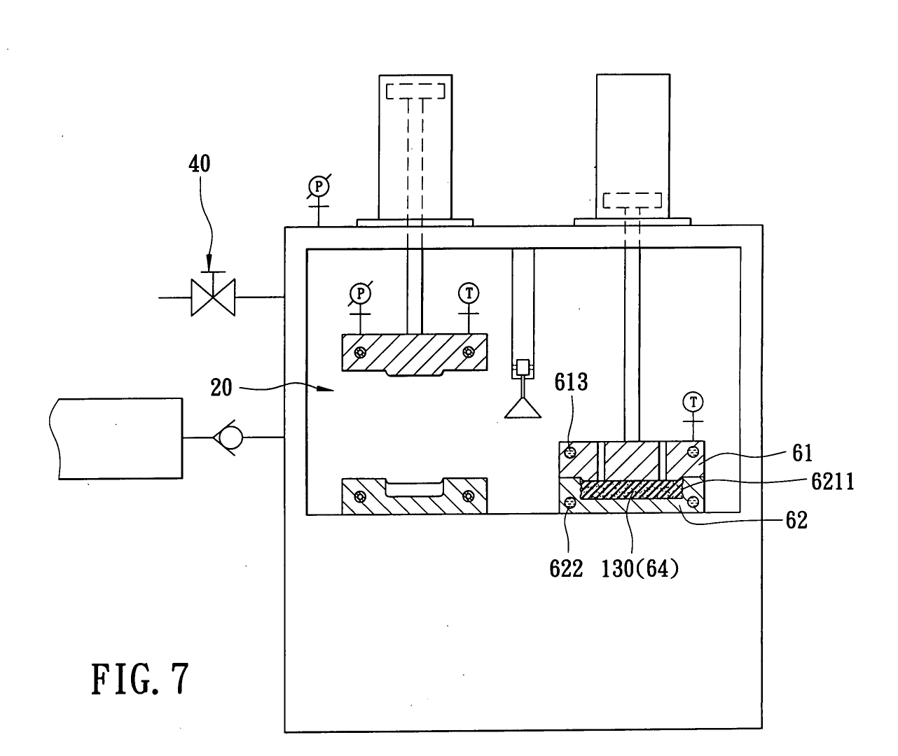

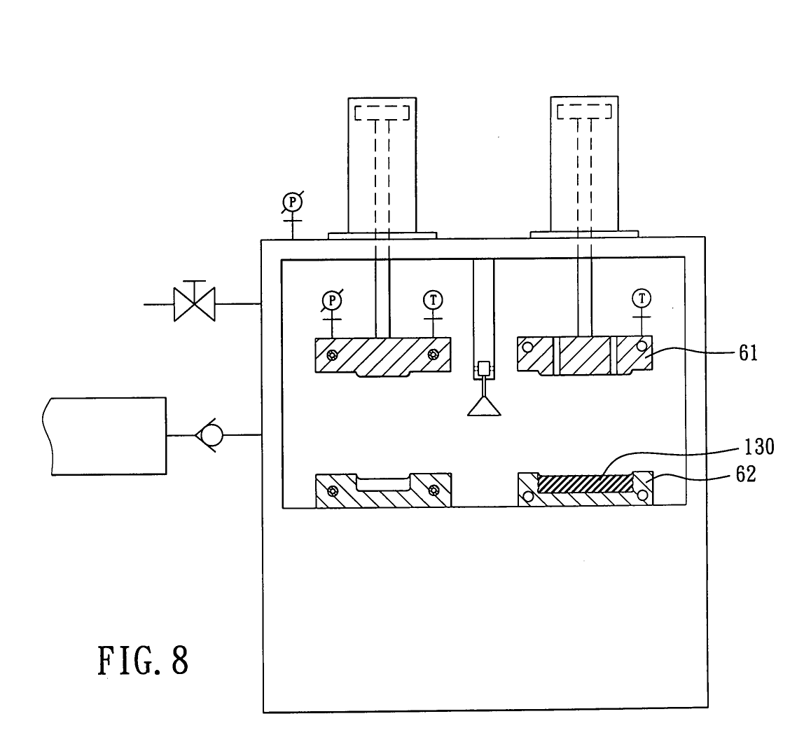

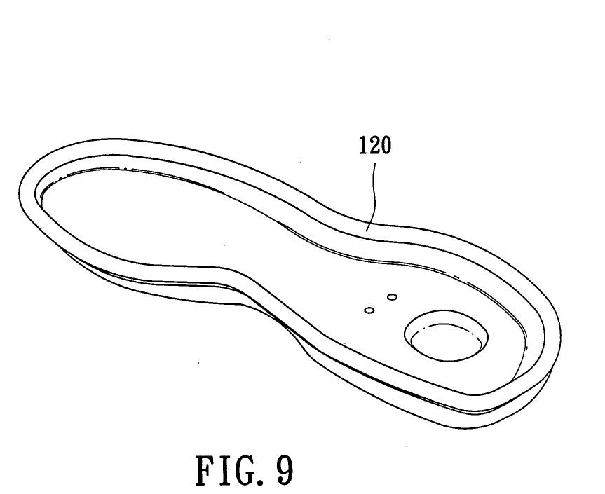

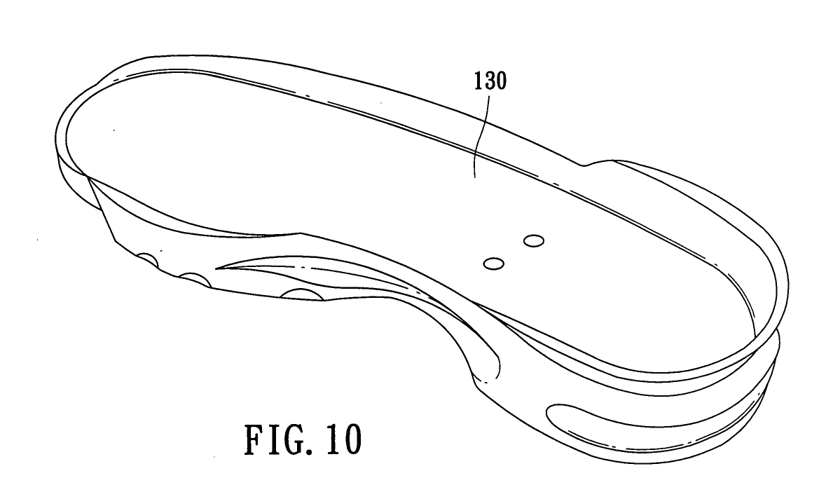

Referring to FIGS. 1 and 2, when the plastic material 110 is injected into the first mold cavity 55 in the first mold unit 50, and the first upper and lower molds 51, 52 are heated by the heating elements 512, 522 to a temperature of about 165° C., the plastic material 110 undergoes cross-linking and foaming so as to form the foamed blank 120 (see FIG. 9), which has a shape corresponding to that of the first mold cavity 55 in the first mold unit 50. A foaming pressure of about 7 kg/cm² is generated within the first mold cavity 55 in the first mold unit 50 by the foamed blank 120. The pressure-supplying unit 70 is operated to adjust the pressure in the pressure chamber 20 to the foaming pressure. Subsequently, referring to FIGS. 3, 4, and 5, the first mold unit 50 is opened so as to permit the foamed blank 120 to be moved from the first mold unit 5 into the second mold cavity 64 in the second mold unit 60. Because the foamed blank 120 (see FIG. 9) is moved between the first and second mold units 50, 60 under the foaming pressure, it is not able to expand so that its shape and size can be maintained to be corresponding to those of the first mold cavity 55. Referring to FIGS. 6 and 7, after the foamed blank 120 is moved into the second mold cavity 64 in the second mold unit 60, the pressure in the pressure chamber 20 is reduced to a forming pressure by operation of the pressure-adjusting valve 40. The forming pressure is equal to one atmospheric pressure, under which the foamed blank 120 can expand within the second mold cavity 64 in the second mold unit 60 to form the foamed body 130, which has a shape corresponding to that of the second mold cavity 64 in the second mold unit 60. Cooling water is introduced into the cooling-water passages 613, 622, as shown in FIG. 7, so as to cool the second upper and lower molds 61, 62 to a temperature of about 20° C.˜25° C. instantly within about 5 to 10 minutes, thereby cooling the foamed body 130 within the second mold cavity 64 in the second mold unit 60 and fixing the shape of the foamed body 130, which now has patterns corresponding to the patterns 6211. Finally, referring to FIG. 8, the second mold unit 60 is opened to obtain the foamed body 130 (see FIG. 10).

In view of the above description, advantages of this invention can be summarized as follows:

1. According to this invention, the pressure in the pressure chamber 20 can be controlled. Because the pressure in the pressure chamber 20 is increased to the foaming pressure prior to opening of the first mold unit 50, the first mold unit 50 is opened under the foaming pressure, and removal of the foamed blank 120 from the first mold unit 50 into the second mold cavity 64 in the second mold unit 60 and closing of the second mold unit 60 are carried out under the foaming pressure. Thus, the size of the foamed blank 120 is fixed. Moreover, because the pressure in the pressure chamber 20 is subsequently reduced from the foaming pressure to the forming pressure, the foamed blank 120 expands and is cooled within the second mold cavity 64 in the second mold unit 60 under the forming pressure. As such, the resultant foamed body 130 has a shape and a size corresponding substantially to those of the second mold cavity 64 in the second mold unit 60. Furthermore, because the foamed blank 120 expands and is cooled under a predetermined pressure (i.e. the forming pressure) to form the foamed body 130, change in ambient or atmospheric pressure would not have any adverse effect on the foamed blank 120 during the forming process. Thus, the production qualification rate of the foamed body 130 can be increased to be as high as 100% and waste of the material can be avoided.

2. When the first mold unit 50 is opened, the foamed blank 120 is moved directly into the second mold cavity 64 in the second mold unit 60, within which the foamed blank 120 expands and is cooled to form the foamed body 130. As such, the foamed body 130 can be formed from the foamed blank 120 within a relatively short period of time. Furthermore, the conventional second molding process and trimming and downsizing operations can be dispensed with, thereby effectively shortening process time (by approximately 3-5 days, as compared with the conventional apparatus including a tunnel type oven).

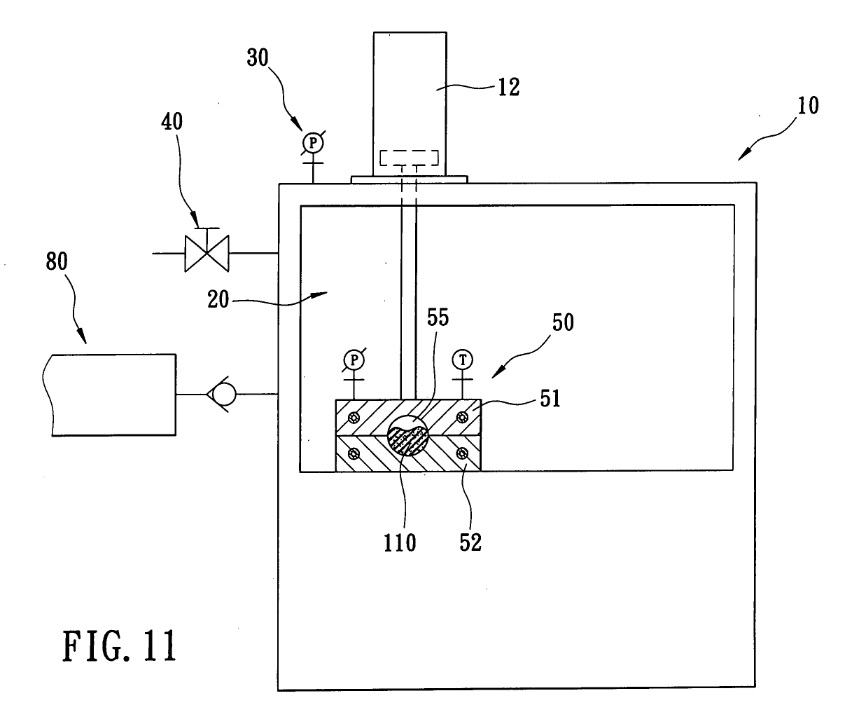

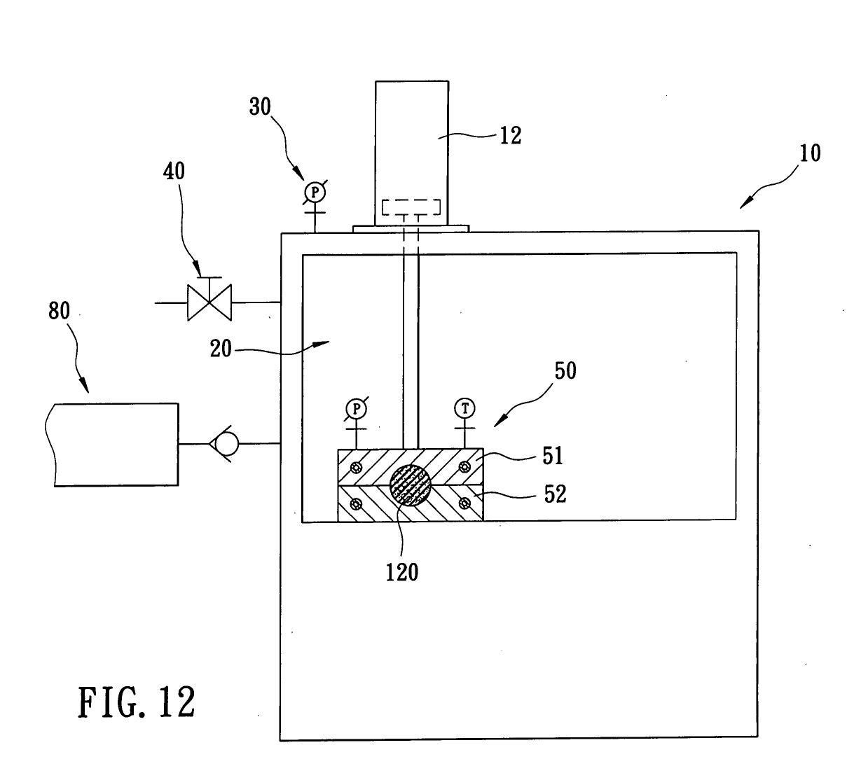

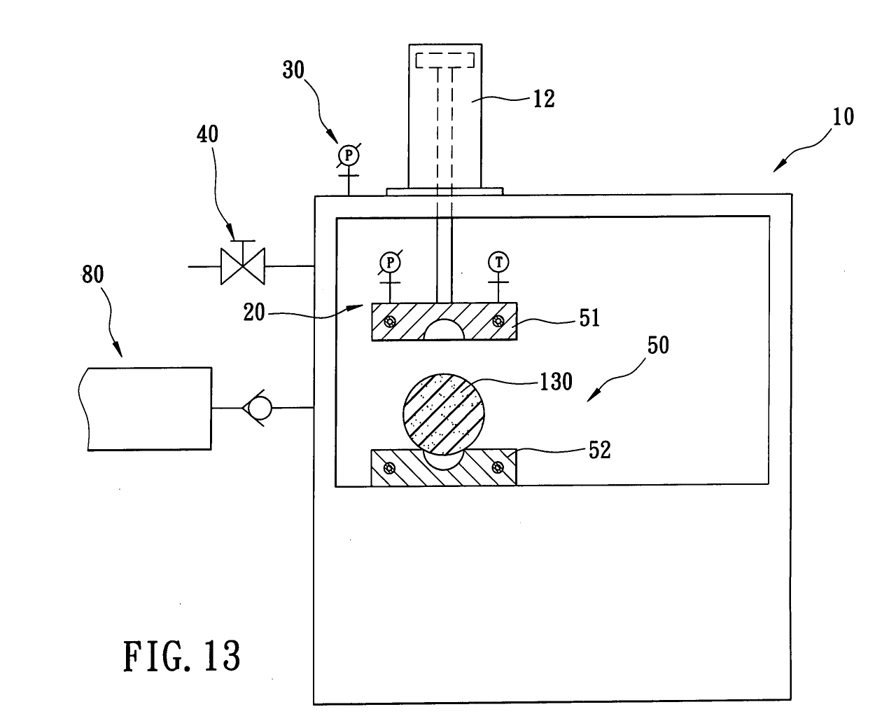

Referring to FIGS. 11, 12, and 13, the second preferred embodiment of a forming apparatus for forming a spherical foamed body 130 from a foamable plastic material 110 according to this invention is shown to include a machine bed unit 10 with a hydraulic cylinder 12, a pressure chamber 20, a pressure-sensing element 30, a pressure-adjusting valve 40, a mold unit 50 consisting of upper and lower molds 51, 52, and a pressure-supplying unit 80. During use, after the first mold unit 50 has been closed, the plastic material 110 is injected into a mold cavity 55 defined between the upper and lower molds 51, 52 to undergo cross-linking and foaming so as to form a foamed blank 120. Subsequently, the pressure in the pressure chamber 20 is adjusted to a forming pressure equivalent to the atmospheric pressure by the operation of the pressure-supplying unit 80. When the mold unit 50 is opened, the foamed blank 120 expands to form the foamed body 130 under the forming pressure. Alternatively, the pressure in the pressure chamber 20 is initially adjusted to the foaming pressure by the operation of the pressure-supplying unit 80. After the mold unit 50 is opened, the pressure in the pressure chamber 20 is adjusted to reduce from the foaming pressure to the forming pressure by the operation of the pressure-adjusting valve 40. Hence, the foamed blank 120 can expand under the forming pressure to form the foamed body 130.

With this invention thus explained, it is apparent that numerous modifications and variations can be made without departing from the scope and spirit of this invention. It is therefore intended that this invention be limited only as indicated by the appended claims.

1. A forming apparatus adapted for forming a foamed body from a foamable plastic material under pressure control, said forming apparatus comprising:
a pressure chamber;
a first mold unit mounted within said pressure chamber, said first mold unit including a first upper mold and a first lower mold that can engage said first upper mold to define a first mold cavity between said first upper and lower molds, the plastic material being placed into said first mold cavity so as to undergo cross-linking and foaming, thereby forming a foamed blank, which generates a foaming pressure within said first mold cavity; and
a pressure-adjusting device operable to adjust a pressure in said pressure chamber to a forming pressure so that said forming pressure is applied to said foamed blank so as to permit said foamed blank to expand, thereby forming the foamed body under said forming pressure.

2. The forming apparatus as claimed in claim 1, wherein said first mold unit further includes a first temperature-sensing element mounted on one of said first upper and lower molds for sensing a temperature of said first upper and lower molds.

3. The forming apparatus as claimed in claim 1, further comprising a second mold unit, said second mold unit being mounted within said pressure chamber and including a second upper mold and a second lower mold that can engage said second upper mold to define a second mold cavity between said second upper and lower molds, said second mold cavity in said second mold unit having a volume larger than that of said first mold cavity in said first mold unit, at least one of said second upper and lower molds being formed with several air passages that are in fluid communication with said second mold cavity and said pressure chamber, said pressure-supplying unit being operable to adjust the pressure in said pressure chamber to said foaming pressure so that the foamed blank can be moved from said first mold unit into said second mold unit under said foaming pressure, after which the pressure in said pressure chamber can be reduced by said pressure-adjusting device to said forming pressure so that said foamed blank expands within said second mold cavity in said second mold unit under said forming pressure to form the foamed body.

4. The forming apparatus as claimed in claim 3, further comprising a conveying unit that is mounted within said pressure chamber and that is located between said first and second mold units for moving said foamed blank from said first mold unit into said second mold unit, said conveying unit including a vertical rotating shaft journalled in said pressure chamber, a connecting rod connected pivotally to and swingable relative to said rotating shaft and having a free end, and a suction cup mounted fixedly on said free end of said connecting rod so as to suck and move said foamed blank from said first mold unit into said second mold unit.

5. The forming apparatus as claimed in claim 3, wherein said pressure-adjusting device includes a pressure-supplying unit for increasing the pressure in said pressure chamber to said foaming pressure before said first mold unit is opened, and a pressure-adjusting valve for reducing the pressure in said pressure chamber from said foaming pressure to said forming pressure after said foamed blank is moved into said second mold cavity in said second mold unit.

6. The forming apparatus as claimed in claim 5, wherein said pressure-supplying unit includes a pressure source in fluid communication with said pressure chamber, and a control valve disposed between said pressure source and said pressure chamber and operable to permit an increase in the pressure in said pressure chamber.

7. The forming apparatus as claimed in claim 6, wherein said pressure source is configured as an air compressor.

8. The forming apparatus as claimed in claim 3, wherein said second mold unit further has a second temperature-sensing element mounted on one of said second upper and lower molds for sensing a temperature of said second upper and lower molds.

9. The forming apparatus as claimed in claim 1, further comprising a pressure-sensing element for sensing the pressure within said pressure chamber.

10. The forming apparatus as claimed in claim 1, wherein said first mold unit further includes a pressure-sensing element mounted on one of said first upper and lower molds for sensing a pressure within said first mold cavity in said first mold unit.
